(19) United States
(12) Patent Application Publication
(10) Pub. No.: US 2013/0149999 A1
(43) Pub. Date: Jun. 13, 2013

(54) LOG-IN SYSTEM FOR WEB IN PLATFORM OF VEHICLE USING NEAR FIELD COMMUNICATION TERMINAL

(71) Applicant: Dae Young Lee, Hwaseong (KR)

(72) Inventor: Dae Young Lee, Hwaseong (KR)

(73) Assignee: Hyundai Motor Company, Seoul (KR)

(21) Appl. No.: 13/490,877

(22) Filed: Jun. 7, 2012

(30) Foreign Application Priority Data
Dec. 7, 2011 (KR) 10-2011-0130032

(51) Int. Cl. H04B 5/06; H04W 12/06

(52) U.S. Cl. 455/411

(57) ABSTRACT

A log-in system for web page access in a vehicular platform using a NFC terminal is provided. The system includes a computer (PC) that stores and manages addresses of web pages that the user has accessed and personal information such as identification (ID) and a password required to log-in for each corresponding web page in a user database (DB). A server receives registration for log-in information from at least one computer via the Internet and manages the log-in information accordingly. A portable terminal having an NFC function downloads and stores information for the web pages, which have been accessed by the portable terminal, and log-in information from the computer or the server. A vehicle platform then receives the log-in information stored in the portable terminal via NFC and automatically executes log-in for an Internet web page based on the log-in information.

### CROSS-REFERENCES TO RELATED APPLICATIONS

This application claims priority to Korean patent application No. 10-2011-0130032 filed on Dec. 7, 2011, the disclosure of which is hereby incorporated in its entirety by reference.

### BACKGROUND OF THE INVENTION

1. Field of the Invention

The present invention relates to technology for improving a log-in method for user identifications and passwords when accessing the web in a vehicular platform, and more particularly, to a log-in system for the web using a near field communication (NFC) terminal configured to safely enable log-in for a corresponding web page while the vehicle is moving by simply inputting the required user information for a corresponding web page via a wireless interface, which has been registered in a NFC terminal in advance, when a driver accesses the corresponding web page through a web accessible platform installed within a vehicle.

2. Description of the Related Art

Web accessible (i.e., next-generation) technology has recently allowed drivers to freely access the web using this web accessible platform in a vehicle. Thus, the number of users accessing Internet using the web accessible platform has been increasing. Unfortunately, as a result of this increased accessibility to modern day technology, accidents caused by users accessing a personal computer (PC) or a smart phone, or watching a digital multimedia broadcasting (DMB) while driving has also significantly increased. These accidents can lead to fatalities or serious injuries. Thus, as with any new telecommunication technology, it is important that safety play an important factor in its implementation and design.

Additionally, since the conventional method of data input via a keyboard has been restricted in recent years by many states. Some new techniques of data input, especially user IDs and passwords, are needed. Although the driver or passenger may input the data through a keypad when the vehicle is stopped, it is still not easy given the space restrictions in the vehicle to do so easily.

Along these lines, an NFC transmits inter-terminal data at short range (e.g., about 10 cm) to another terminal when the device installed with the NFC is positioned within range of the other device. Once the device recognizes that the NFC terminal is within range, it sends a confirmation request to the NFC device, if the user confirms the transmission, the NFC device inputs the data into the receiving device accordingly. If the user does not confirm the transmission, the transmission/connection is terminated. NFC terminals have been implemented into the smart phones. However, there is currently no way of implementing the NFC terminal into a vehicular platform.

### SUMMARY OF THE INVENTION

Various aspects of the present invention have been made in view of the above problems, and provide a log-in system for web accessibility using a near field communication (NFC) terminal configured to safely enable log-in to a corresponding web page while a vehicle is moving by dynamically inputting required user information for the corresponding web page via a wireless interface. This using user information has been registered in a NFC terminal in advance and is used an input for a specific web page when a driver accesses the corresponding web page through a web accessible platform within a vehicle.

According to an aspect of the present invention, a log-in system for a web accessible platform of a vehicle uses a near field communication (NFC) terminal to safely access web content while the vehicle is moving. The system may include: a computer (e.g., a personal computer (PC)) configured to store and manage addresses of web pages to which a user has previously accessed and personal information such as an (ID) and a password required to log-in to a corresponding web page in a user database (DB) therein. An operator center, e.g., a server, is configured to receive registration for log-in information from at least one computer which is connected to the Internet. The server manages the log-in information for individuals so that data is secured and organized appropriately. A portable terminal (e.g., a personal portable terminal) having an NFC function is configured to download and store information for each web page that the user intends to access (i.e., web pages which have been accessed by the personal portable terminal), and log-in information from the computer or the server. A vehicle platform is configured to receive the log-in information stored in the personal portable terminal through NFC and automatically execute log-in for an Internet web page based on the log-in information.

The computer may be configured to be directly connected to the personal portable terminal via a wired or wireless connection and share the web page information and the log-in information with the portable terminal. The portable terminal may be configured to allow the user to directly input and register the web page information and the log-in information through various forms of data input.

The server may be configured to be directly connected to the portable terminal through a wireless Internet connection and share the web page information and the log-in information with the portable terminal.

The vehicle platform may include an NFC reader configured to receive NFC from the portable terminal and recognize user information stored within a storage unit in portable terminal. The vehicle platform may also include a key input unit configured to allow a user to input data. A network interface may be configured to execute Internet access via wireless communication. Furthermore, a data storage unit may be configured to store the user information read through the NFC reader, and a display unit may be configured to display functions, operational states, data etc. A control unit may be configured to control the overall operation of the log-in system.

In some exemplary embodiments of the present invention, the portable terminal may be implemented within a smart phone having an NFC function. The vehicle platform may be configured of a combination of a head unit and a telematics unit mounted in a vehicle. The network interface and the data storage unit may be configured of the telematics unit. The key input unit may be implemented with a key panel or a screen having a touchable input function.

In the exemplary embodiment of the present invention having the above-described configuration, a user previously registers the personal information such as an ID and password required in log-in for each web page in his/her own portable terminal having an NFC function and causes the portable terminal to simply recognize a reader of a vehicle platform when the user accesses to a corresponding web page through the vehicle platform so that the user is automatically logged into he web page.

Thus, in the illustrative embodiment of the present invention, the user can easily perform the log-in for the web page without any key input. Accordingly, accidents are prevented due to terminal operation while driving, rather than the driver having to input the data manually. In addition, motivation for allowing web access to be generalized and activated through the vehicle platform is provided with ease of the web access in a vehicle.

The apparatuses and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram illustrating a configuration of a log-in system for web using an NFC terminal in a platform within a vehicle according to an exemplary embodiment of the present invention.

FIG. 2 is a view illustrating a structure of a user information DB.

FIG. 3 is a flowchart illustrating an operation of the log-in system having the configuration of FIG. 1.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

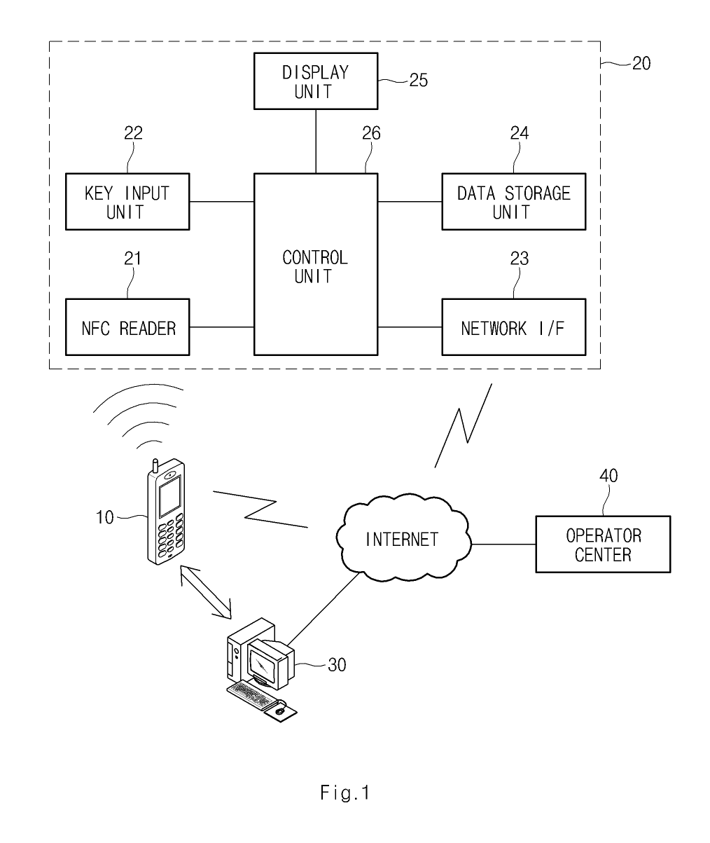

FIG. 1 is a block diagram illustrating a configuration of a log-in system for web page using an NFC terminal in communication with a platform within a vehicle according to an exemplary embodiment of the present invention. In FIG. 1, a smart phone 10 represents a user's portable phone having an NFC function. A vehicle platform 20 is a platform mounted in a vehicle and includes an NFC reader 21 configured to perform NFC communication with the smart phone 10 and recognize user information stored in the smart phone 10, a key input unit 22 configured to input data by the user, a network interface 23 configure to execute Internet access via wireless communication, a data storage unit 24 configured to store the user information read through the NFC reader 21, a display unit 25 configured to display an operational state of the log-in system, and a control unit 26 configured to control the overall operation of the log-in system.

The vehicle platform 20 may be configured of a combination of a head unit and a telematics unit mounted in the vehicle. In this case, the network interface 23 and the data storage unit 24 may be integrated into the telematics unit. Furthermore, the key input unit 22 may be embodied as a key panel or a screen having a touchable input function.

A computer 30 may be, for example, a user's personal computer (PC) which is configured to have previously stored addresses for web pages to which the user has accessed and personal information such as an ID and password required in log-in for a corresponding web page in a user DB. The PC may be configured to automatically transmit corresponding information to the smart phone 10 when the smart phone 10 is accessed thereto in a wired or wireless manner.

An operation center 40 is connected to the vehicle platform 20, the smart phone 10, and the computer 30 via the Internet. The operation center 40 is configured to have registered log-in information managed by at a plurality of users through their own computers 30. The server 40 stores and manages web information and log-in information transmitted from the plurality of computers accessed thereto through the Internet in regions divided into and allocated to individuals therein.

Subsequently, an operation of the log-in system having the above-described configuration will be described. When new vehicles are shipped, memory regions in which an identification number of a corresponding vehicle is set to a vehicle identification number (VIN) are allocated to a DB of the server 40.

Once a user installs a tool-bar provided from the operator center 40 (server) in his/her own computer 30, the tool bar then begins to store and monitor websites that the user regularly accesses (or accesses depending on the personal settings of the user). The user then allows the tool bar program from the operator center 40 to automatically store the addresses of web pages to which the user has accessed and personal information such as an ID and password required in logs-in for each corresponding web page. This personal information for that particular user is then managed in a user information DB allocated to a separate region of a memory in the computer.

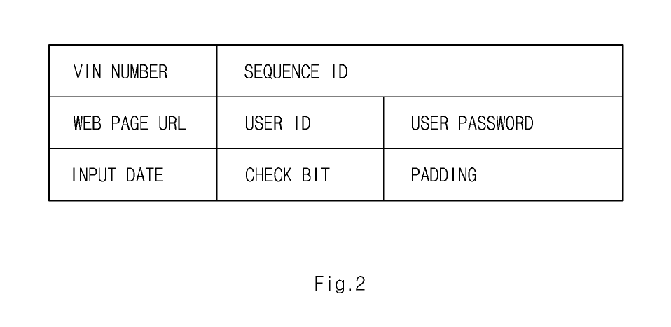

As shown in FIG. 2, a structure of the user information DB includes a sequence ID, a web page uniform resource locator (URL), a user ID, a user password, an input date, a check bit configured to check a transmission error, and a padding on the basis of a VIN number designated as VIN. The sequence ID denotes an order of data in the DB and is used to classify the data in the DB.

The information stored in the computer 30 is periodically updated in the DB of the operator center 40 via the Internet and when the smart phone 10 is connected to the computer 30. Corresponding information is also transmitted to the smart phone 10, stored and registered in a memory of the smart phone 10.

The smart phone 10 may directly access to the DB of the operator center 40 through the Internet without passing through the computer 30 and allow corresponding information to be downloaded. Alternatively, the user may directly input and set web information and the user information through an input device on the smart phone 10. The series of operations may also be performed by applications installed by the smart phone 10.

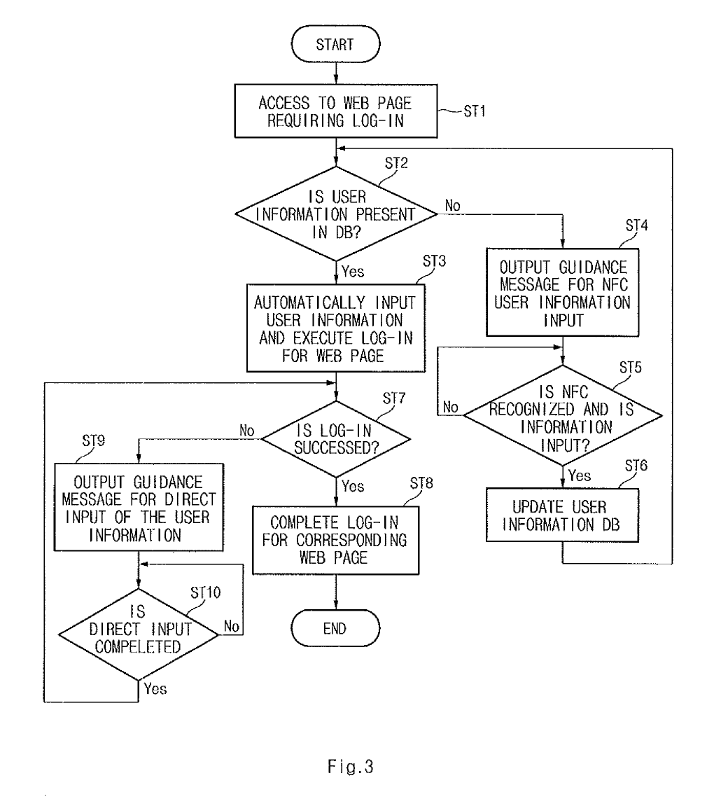

A process of logging-in to a web page through an NFC function of the smart phone 10 in a state that the web information and the user information have been stored in the smart phone 10 of the user by the above-described process will be described with reference to a flowchart of FIG. 3.

When the user tries to access to a web page requiring log-in through the key input unit 22 of the vehicle platform 20 (ST1), the control unit 26 indexes the user information DB of the data storage unit 24 and confirms whether or not user information required in log-in for a corresponding web page is present in the user information DB (ST2).

When it is determined that the user information required in the log-in is present in the user information DB in step ST2, the control unit 26 executes log-in via corresponding user information (ST3). When it is determined that the user information required in log-in is not present in the user information DB in step ST1, the control unit 26 outputs a guidance message requiring the user information be input through NFC recognition of the smart phone 10 via the display unit 25 (ST4).

Next a driver confirms the guidance message, and as a result the NFC reader 21 recognizes his/her own smart phone 10. Upon doing so, the control unit 26 confirms whether or not user information input is executed through NFC (ST5). When it is confirmed that the user information input is executed in step ST5, the control unit 26 updates the user information input by the NFC to the user information DB of the data storage unit 24 (ST6) and then the control unit 26 returns to a process of step ST2 and re-confirms whether or not the user information required in log-in is present.

After the above-described processes for the user information update and the log-in are executed, the control unit 26 confirms whether or not the log-in is successfully executed (ST7). When it is determined that the user information for log-in of a corresponding web page is provided and the log-in is successfully executed in step ST7, the control unit 26 determines whether or not the log-in for the corresponding web page has been normally completed and ends the process (ST8). When it is determined that the log-in is not successfully executed in step ST7, the control unit 26 outputs a second guidance message requiring direct input of the user information through the display unit 25 (ST9).

Once the driver confirms the second guidance message and directly inputs the user information through the key input unit 22, the control unit 26 confirms whether or not the user information input has completed (ST10). When it is determined that the user information input has completed in step ST10, the control unit 26 returns to a process of ST7 and executes log-in based on the user information directly input by the user. When it is determined that the log-in is successfully completed in step ST7, the control unit 26 determines that the log-in for the corresponding web page by the NFC recognition and ends the series of control operations.

According to the exemplary embodiment, when a user accesses to a web page through a web accessible platform in a vehicle, user information required in a web page can simply input through an Internet interface using the user information which has been previously registered in an NFC terminal. Therefore, a log-in system using the NFC terminal in a platform of a vehicle capable of safely logging-in during driving can be implemented.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Although the above exemplary embodiment is described as using a plurality of units to perform the above process, it is understood that the above processes may also be performed by a single controller or unit.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A log-in system for web using a near field communication (NFC) terminal in a platform of a vehicle, the system comprising:
a computer configured to store and manage addresses of a plurality of web pages to which a user has previously accessed and personal information including at least an identification (ID) and a password required in log-in for each corresponding web page of the plurality of web pages in a user database (DB) therein;
a server configured to receive registration for log-in information from at least one computer, the server accessed via Internet and configured to manage the log-in information for each computer separately;
a portable terminal having an NFC function configured to download and store information for each of the plurality of web pages, which have been accessed by the portable terminal, and log-in information from the computer or the server; and
a vehicle platform configured to access a web page via an internet connection,
wherein the vehicle platform is configured to confirm whether or not user information required during log-in for a corresponding web page is present in a user information database stored on the vehicle platform to automatically execute log-in of the corresponding web page via the user information without having to access the portable terminal.

2. The system of claim 1, wherein the computer is configured to be directly connected to the portable terminal in a wired or wireless manner and share the web page information and the log-in information with the portable terminal.

3. The system of claim 1, wherein the portable terminal is configured to allow the user to directly input and register the web page information and the log-in information through key input.

4. The system of claim 1, wherein the server is configured to be directly connected to the portable terminal through wireless Internet and share the web page information and the log-in information with the portable terminal.

5. The system of claim I, wherein the vehicle platform includes:
an NFC reader configured to perform NFC with the portable terminal and recognize user information stored on the portable terminal;
a key input unit configured to allow a user to input data;
a network interface configured to initiate Internet access via wireless communication;
a data storage unit configured to store the user information read by the NFC reader;
a display unit configured to display an operational state of the log-in system; and
a control unit configured to control an overall operation of the log-in system.

6. The system of claim 1, wherein the portable terminal is implemented within a smart phone having an NFC function

7. The system of claim 5, wherein the vehicle platform is includes a head unit and a telematics unit mounted in a vehicle,
wherein the network interface and the data storage unit are incorporated into the telematics unit.

8. The system of claim 5, wherein the key input unit is a screen having a touchable input function.

9. A vehicle platform configured to automatically log in a user on a particular web page, the vehicle platform comprising:
a near field communication (NFC) reader configured to receive and transmit NFC with a portable terminal and recognize user information stored on the portable terminal;
a telematics unit configured to initiate Internet access via wireless communication and store the user information read by the NFC reader;
a display unit configured to display information and operational messages to the user;
a data storage unit configured to store the user information read by the NFC reader; and
a control unit configured to automatically execute log-in of a web page accessed by the vehicle platform via corresponding log-in information when the log-in information for the corresponding web page is present in the user information database of the data storage unit without having to access the portable terminal, wherein the log-information includes at least an identification (ID) and a password required in log-in for a web page of a plurality of web pages stored on a remote user database (DB).

10. A method for near field communication (NFC) in a vehicle platform comprising:
storing and managing, by a computer, addresses of a plurality of web pages to which a user has previously accessed and personal information including at least an identification (ID) and a password required in log-in for each corresponding web page of the plurality of web pages in a user database (DB) therein;
receiving, by an server, a registration for log-in information from the computer via Internet
managing, by the server, the log-in information for each computer separately;
downloading and storing, by a portable terminal having an NFC function, information for each of the plurality of web pages, which have been accessed by the portable terminal, and log-in information from the computer or the server;
executing automatically, by the vehicle platform, log-in for a corresponding web page via corresponding log-in information when the log-in information for the corresponding web page is present in the user information database within the vehicle platform without having to access the portable terminal.

11. A non-transitory computer readable medium containing program instructions executed by a processor or controller, the computer readable medium comprising:
program instructions that interpret and transmit near field communication (NFC) with a portable terminal and recognize user information stored on the portable terminal;
program instructions that initiate Internet access via wireless communication and store the user information read by the NFC reader;
program instructions that display information and operational messages to the user; and
program instructions that automatically execute log-in for a web page via corresponding log-in information when log-in information is present in a user information database stored within a a vehicle platform without having to access a portable device,
wherein the log-information includes at least identification (ID) and a password required in log-in for a web page of a plurality of web pages stored on a remote user database (DB).

12. The system of claim 1, wherein the vehicle platform updates log-in information received from the portable terminal via NFC to the user information DB to execute log-in for the corresponding web page based on the received log-in information when the user information required in the log-in is not present in the user information database.

13. The vehicle platform of claim 9, wherein the control unit updates log-in information received from the portable terminal via NFC to the user information DB to execute log-in for the corresponding web page based on the received log-in information when the user information required in the log-in is not present in the user information database.

14. The method of claim 10, further comprising: receiving, at the vehicle platform, the log-in information stored in the portable terminal via NFC and automatically executing log-in for a web page based on the received log-in information when the log-in information for the corresponding web page is not present in the user information database.

15. The non-transitory computer readable medium of claim 11, further comprising program instructions that interpret log-in information stored in the portable terminal via NFC and automatically execute log-in for Internet web page based on the received log-in information when the log-in information is not present in the user information database
